(19) United States
(12) Patent Application Publication
(10) Pub. No.: US 2012/0218594 A1
(43) Pub. Date: Aug. 30, 2012

(54) METHOD AND SYSTEM FOR FULFILLING A CUSTOMER'S PRINT JOB NEEDS BY SELECTING AND ASSIGNING THE PRINT JOB TO ONE OR MORE QUALIFIED PRINTERS FROM A GROUP OF PARTICIPATING PRINTERS

(75) Inventors: Naoki KOMINE, Hawthorne, CA (US); Isao HAYAMI, Kanagawa (JP)

(73) Assignee: KONICA MINOLTA LABORATORY U.S.A., INC., San Mateo, CA (US)

(21) Appl. No.: 13/036,934

(22) Filed: Feb. 28, 2011

(51) Int. Cl. G06F 3/12

(52) U.S. Cl. 358/1.15

(57) ABSTRACT

A system and method for fulfilling a customer's print job needs through a process carried out by an online platform. The process includes the steps of receiving the print job with particular requirements from the customer, and retrieving from database profiles of a multiplicity of participating print shops to determine which print shop or print shops can handle the print job by matching all of the particular requirements. If it is determined that there is one print shop suitable to handle the print job by best matching all of the particular requirements, then assign the print job to the one suitable print shop. If it is determined that more than one print shop is needed to handle the print job, then split the print job and assign the split print job to a plurality of suitable print shops that together can best match all of the particular requirements of the print job.

### BACKGROUND OF THE INVENTION

1. Field of the Invention

This invention relates generally to a method and system for fulfilling a customer's print job requirements and, more particularly, it relates to a method and system for fulfilling a customer's print job requirements by selecting and assigning the print job to one or more qualified printers from a group of participating printers.

2. Description of Related Art

In today's society, customers often have various print jobs that need to be processed. Sometimes a print job is a small project that can be handled by a small local printer with whom the customer is familiar. But often times the print job is more complicated and requires complex manipulations that cannot be handled by the local printer. In such cases, the customer needs to find a suitable printer to handle the job. For example, the print job may require large volume printing or may require finishing manipulations none of which their local printer can support. In other cases, the local printer may not be able to meet the customer's deadline or may simply charge more than the customer is willing to pay. In these cases, the customer needs more printing options than the local printer can provide.

Most large print jobs that require high volume printing on more sophisticated printing machines are handled by print shops. In this application the term “print shop” generally refers to an environment of professional print shops, publishing workshops, print/copy departments of large organizations or business entities, and/or press unit of educational institutions such as colleges and universities, where a variety of print job requests such as large-volume duplication or document printing needs to be processed and completed by utilizing multiple printers within a specified turn-around time.

There have been some efforts in the market place to address the customers' need of selecting a suitable printer for a specific print job. For example, U.S. Pat. No. 7,788,143 issued to Gindlesperger on Aug. 31, 2010 for “System and Method for Competitive Pricing and Procurement of Customized Goods and Services” disclosed a system and method for selecting a lowest bidding printer from multiple printers of a customized print job, including receiving a set of attributes from each of the multiple printers representing their respective capabilities, and receiving an invitation-for-bid data from the customer defining a print job for which the customer desires price quotes or bids, where the printer attributes and/or the invitation-for-bid are received through a web browser, and the invitation-for-bid is compared to each of the printer's attributes according to certain standard or optional selection criteria to generate a printer selection pool of printers qualified to bid on the job, such that each printer in the printer selection pool receives a printer's invitation-for-bid. After a bid is received from at least one printer in the printer selection pool, the lowest price bid is identified, the customer is informed of the identity of the selected printer, and solicited for approval of the selected printer. Upon receipt of approval from the customer, an order is issued to the selected printer and the non-selected printers in the selection pool are also informed of the bid prices and of the selection results.

A bidding process as described in Gindlesperger may be useful but often cause unnecessary delay to the process, as the invitations-for-bid need to be sent out and responses to the invitation need to be received before a printer can be selected for the job. In addition, in printing industry it is particularly important to consider whether a print shop is qualified to handle a print job based on the printing volume of the print shop. In other words, even if a print shop is qualified in other aspects for a print job, it would not be appropriate to assign the print job to the print shop if it cannot finish the complete print job by the due date required by the customer due to the volume capability of the print shop. Furthermore, the primary objective of a print shop selection platform should not necessarily be selecting and awarding a customer's print job to one printer, but rather best fulfilling the customer's print job need even if splitting the print job among different printers are needed. Therefore, there remains a growing need for providing a platform for helping consumers to find and select suitable print shops for their print jobs without necessarily involving an active bidding process or necessarily awarding the print job to just one print shop, but rather splitting a customer's print job if needed and selecting and awarding more than one printer shops so that the customer's print job can be best handled.

### SUMMARY

The present invention is directed to a method and system for fulfilling a customer's print job need by selecting and assigning the print job to one or more printers of a group of participating printers.

An object of the present invention is to provide an online platform or portal for helping consumers to find and select suitable print shops to fulfill their print job needs.

Another object of the present invention is to fulfill a customer's print job requirements by selecting suitable print shop(s) based on previously gathered and updated information of the print shops without an active bidding process.

A further object of the present invention is to fulfill a customer's print job needs by splitting the print job if necessary and assigning the split print job to more than one suitable printer shops to best handle the print job as needed.

To achieve these and/or other objects, as embodied and broadly described, the present invention provides a method and system for fulfilling a customer's print job needs through a process carried out by an online platform. In one preferred embodiment, the present invention system includes one or more data processing apparatus each having a non-transitory memory storing a computer software program and a processor executing the computer software program, wherein the computer software program includes program code configured to cause at least one data processing apparatus to execute a process implementing the present invention method.

In another preferred embodiment, the present invention includes a computer software program product having a computer readable program code embedded in a computer usable non-transitory storage medium for controlling at least one data processing apparatus, where the computer readable program code is configured to cause at least one data processing apparatus to execute the process implementing the present invention method.

An exemplary process of one preferred embodiment of the present invention includes the steps of receiving the print job with particular requirements from the customer, and then retrieving profiles from a multiplicity of participating print shops to determine which print shop or print shops are suitable to handle the print job by matching all of the particular requirements. If it is determined that the print job is capable of being handled by a cooperation of multiple print shops, then split the print job and assign the split print job to a plurality of suitable print shops that together can best match all of the particular requirements of the print job.

Additional features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

It is to be understood that both the foregoing general description and the following detailed description are exemplary and explanatory and are intended to provide further explanation of the invention as claimed.

### BRIEF DESCRIPTION OF THE DRAWINGS

FIG. 1 is a schematic block diagram illustrating an exemplary online platform for helping print job customers to select suitable print shops where embodiments of the present invention may be implemented.

FIG. 2 is a schematic block diagram illustrating an exemplary service provider portal server for providing the online platform according to an embodiment of the present invention.

FIG. 3 is a schematic block diagram illustrating an exemplary customer computer system for accessing the online platform according to an embodiment of the present invention.

FIG. 4 is a schematic block diagram illustrating an exemplary print shop server and printers connected to the online platform according to an embodiment of the present invention.

FIG. 5 is a flow chart showing an exemplary process implementing a method for helping print job customers to select suitable print shops through an online platform according to an embodiment of the present invention.

### DETAILED DESCRIPTION OF PREFERRED EMBODIMENTS

Embodiments of the present invention provide a method and system for assisting print job customers to select suitable print shops to fulfill their print job needs. The present invention method may be implemented by a computer software program that has program codes and instructions for implementing the steps of the present invention.

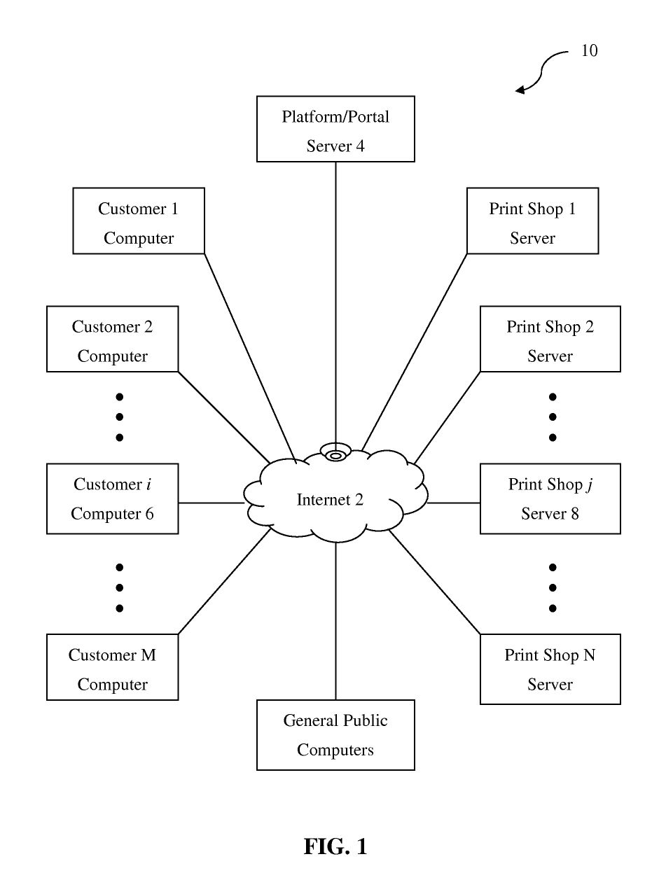

Referring to FIG. 1, there is shown a schematic block diagram illustrating an exemplary system set up or arrangement 10 in which various embodiments of the present invention may be implemented. The present invention set up or arrangement 10 includes an online service on an open computer network such as the Internet 2 for helping print job customers to select suitable printer shops for their printing needs. The online service is provided by utilizing one or more servers 4 which is connected to the Internet 2, where the computer program implementing the present invention process is installed and executed to provide the online platform or portal.

The platform server 4 is connected via the Internet 2 with a multiplicity of computers of consumers 1, 2, . . . , i,. . . , M respectively, where computer 6 of consumer i is representative and will be described in detail below. The platform server 14 is also connected via the Internet 2 with a multiplicity of servers of print shops 1, 2,. . . , j, . . . , N respectively, where server 8 of print shop j is representative and will be described in detail below.

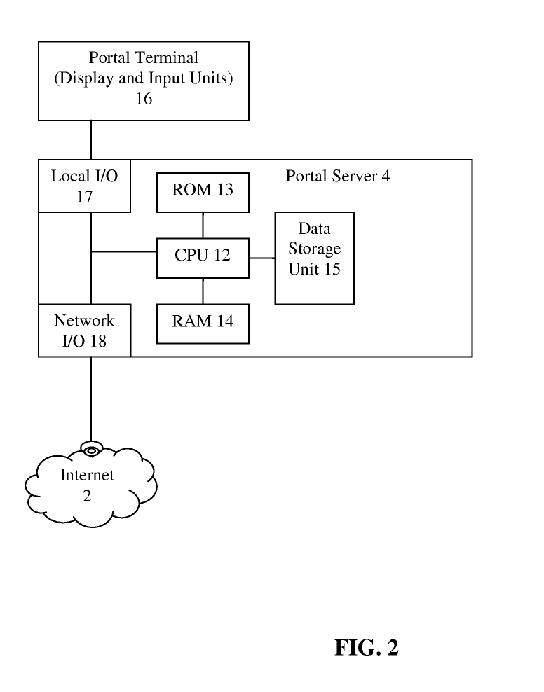

Referring to FIG. 2, there is shown a schematic block diagram illustrating an exemplary set up or arrangement of a portal server 4, whereupon various embodiments of the present invention may be implemented. The server 4 typically includes a central processor unit (CPU) 12 that controls the function and operation of the server 4 and execute computer instructions and programs that may be installed or saved on a read only memory (ROM) 13, a random access memory (RAM) 14, or a data storage unit 15 (such as a hard disc drive or a flash memory) coupled to the CPU 12. One or more portal terminals 16 (each may have its display and input units) may be connected to the server 4 to enable a server operator and/or service representative to interact with the server 4. Alternatively the server 4 may have its own integrated display and input units to enable an operator or representative to interact with the server 4. The server 4 typically also has a local input/output (I/O) port 17 for connection with the portal terminal 16, and a network I/O port 18 for connection to a network such as the Internet 2 so that the server 4 may remotely communicate with the customer computers 6 and print shop servers 8 via the Internet 2. It is understood that portal server 4 may be any suitable computer or any suitable data processing apparatus.

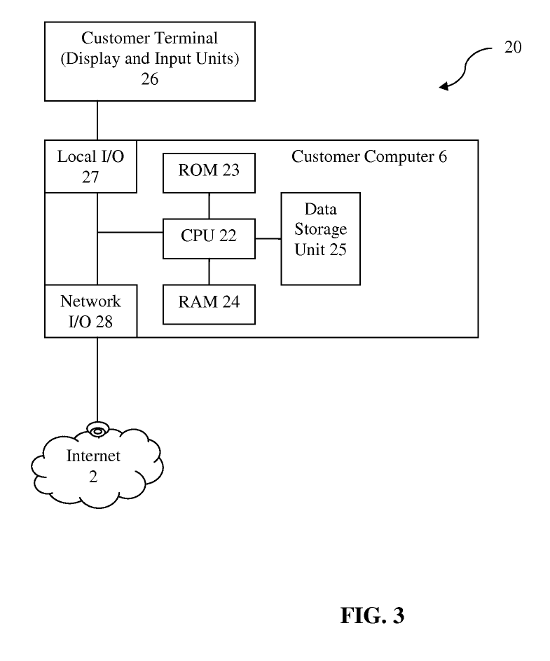

Referring to FIG. 3, there is shown a schematic block diagram illustrating an exemplary set up or arrangement 20 of a customer computer 6, whereupon various embodiments of the present invention may be implemented. The customer computer 6 typically includes a central processor unit (CPU) 22 that controls the function and operation of the computer 6 and execute computer instructions and programs that may be installed or saved on a read only memory (ROM) 23, a random access memory (RAM) 24, or a data storage unit 25 (such as a hard disc drive or a flash memory) coupled to the CPU 22. One or more user terminals 26 (each may have its display and input units) may be connected to the computer 6 to enable a customer and/or user to interact with the computer 6. Alternatively the computer 6 may have its own integrated display and input units to enable a customer or user to interact with the computer 6. The computer 6 typically also has a local input/output (I/O) port 27 for connection with the user terminal 26, and a network I/O port 28 for connection to a network such as the Internet 2 so that the computer 6 may remotely communicate with the platform server 4 and print shop servers 8 via the Internet 2. It is understood that customer computer 6 may be any suitable computer, such as a desktop computer, a laptop computer, a server, a notebook computer, a netbook computer, a tablet computer such as iPad®, or any suitable data processing apparatus including but not limited to smart-phones such as iPhone®, iPod Touch® and other handheld devices that have suitable data processing capabilities.

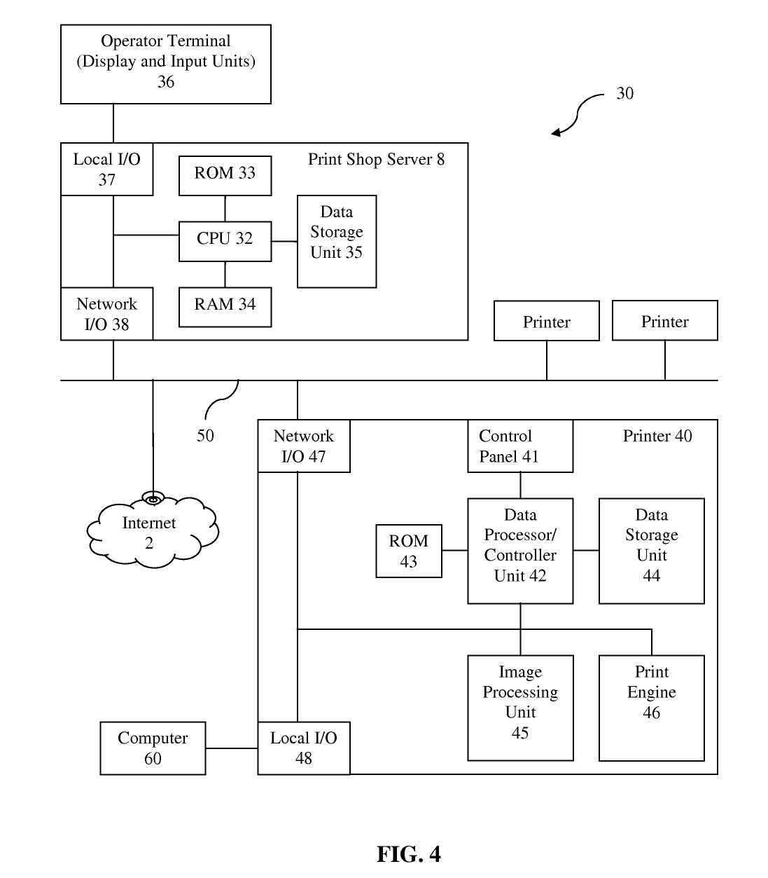

Referring to FIG. 4, there is shown a schematic block diagram illustrating an exemplary print shop printing system set up or arrangement 30, whereupon various embodiments of the present invention may be implemented. In this patent application the term “print shop” refers to an environment of professional print shops, and publishing workshops, where a variety of print requests (including print on demand (POD) requests), such as large-volume duplication and large document printing, needs to be processed and completed by utilizing multiple printers within a specified turn-around time.

In the exemplary print shop printing system set up or arrangement 30, a multiplicity of color and/or black and white printers are connected to and controlled by the printer shop server 8 through a data communication channel 50 which may be a wired or wireless network, a serial bus or a dedicated cable. One or more of the printers, such as printer 40, may also be directly connected to and controlled by a local computer 60. Other devices (not shown) may also be connected to the server 8, the local computer 60 or network channel 50, such as scanners, finishing devices, etc., as part of the printing system set up or arrangement 30. The print shop system 30 may also include a number of “off-line” (or “off-network”) devices (not shown) that are not connected to the network, which devices may be any type of devices used in the print shop, such as finishing devices, prepress devices, etc.

In this application the term “printer” may refer to small desk-top printers typically seen in an office environment, or large digital printing systems used in print/copy departments at large organizations or professional print shops. The term may also cover other similar image and document processing devices such as copiers or multifunction (“all-in-one”) printers that also have copier, scanner and/or facsimile functions. The printer may be directly attached to a computer or server locally, or connected to a computer or server through a network remotely, where the computer or server are used to manage a print job to be processed by the printer. The printer may have multiple paper trays to store paper of various sizes, color, and types. Further, the printer may be equipped with a sophisticated output sorting mechanism with multiple output trays to perform collate printing or other print finishing functions.

As shown in FIG. 4, the print shop server 8 typically includes a central processor unit (CPU) 32 that controls the function and operation of the server 8 and execute computer instructions and programs that may be installed or saved on a read only memory (ROM) 33, a random access memory (RAM) 34, or a data storage unit 35 (such as a hard disc drive) coupled to the CPU 32. One or more print shop operator terminals 36 (each may have its display and input units) may be connected to the server 8 to enable print shop operators and/or users to interact with the server 8 and/or the rest of the print shop system 30. Alternatively the server 8 may have its own integrated display and input units to enable print shop operators and/or users to interact with the server 8 and/or the rest of the print shop system 30. The server 8 typically has a local input/output (I/O) port 37 for connection with the user terminal 36, and a network I/O port 38 for connection to the data communication channel 50. Through the network channel 50 the server 8 is also connected to the external computer network such as the Internet 2 so that the server 8 can remotely communicate with the platform server 4 and customer computers 6 via the Internet 2. It is understood that print shop server 8 may be any suitable computer or any suitable data processing apparatus.

As also shown in FIG. 4, the printer 40 typically has a control panel 41, a controller or control unit 42 which controls the other internal units of printer 40 and is connected to the control panel 41, read-only memory (ROM) 43 and a data storage unit 44. The control panel 41 is accessible by a user and may include a display screen such as a liquid crystal display (LCD) display screen and user input means such as keys, buttons, touch screen, etc., for a user to communicate with and control the function and operation of printer 40. The printer 40 also has an image processing unit 45 and a print engine 46. The printer 40 typically has a network input/output (I/O) port 47 for connection with the print shop server 8, and a local I/O port 48 for optionally connecting to the local computer 60.

It is understood that while FIG. 4 shows a print shop environment, the present invention is not limited to any physical setting of a print shop or network, and can be applied to a printing system having a distributed setting where printers at different locations are connected to one print shop server. In particular, it should be apparent that one or more of the components of the printing system can communicate with the rest of the system via virtual private network (VPN) or similar means through the Internet 2.

The present invention provides an online service for helping print job customers to select the most suitable print service by at least one print shop preferably by operating an online platform or portal on the platform server 4 as described above. The computer software program that implements one preferred mode of the present invention method and process may be installed on the platform server 4, and its application modules or client-end component parts may be installed on the customer computers 16 and/or printer shop servers 8 (or on the printer 40 or local computer 60). When a platform server operator executes the exemplary software program of the present invention, the platform server 4 carries out various respective functions of the software to perform the platform service provider part of the exemplary process of the present invention. When a customer executes an application module of the exemplified software program of the present invention from the customer's end, the customer computer 6 carries out various respective functions of the software to perform the customer part of the exemplary process of the present invention. When a print shop operator executes an application module of the exemplified software program of the present invention from the print shop's end, the printer shop server 8 carries out various respective functions of the software to perform the print shop part of the exemplary process of the present invention. Together the execution of the various application modules of the exemplary software program of the present invention by the platform server 4, customer computers 6 and/or printer shop servers 8 cause the performance and completion of the exemplary method and process of the present invention described below.

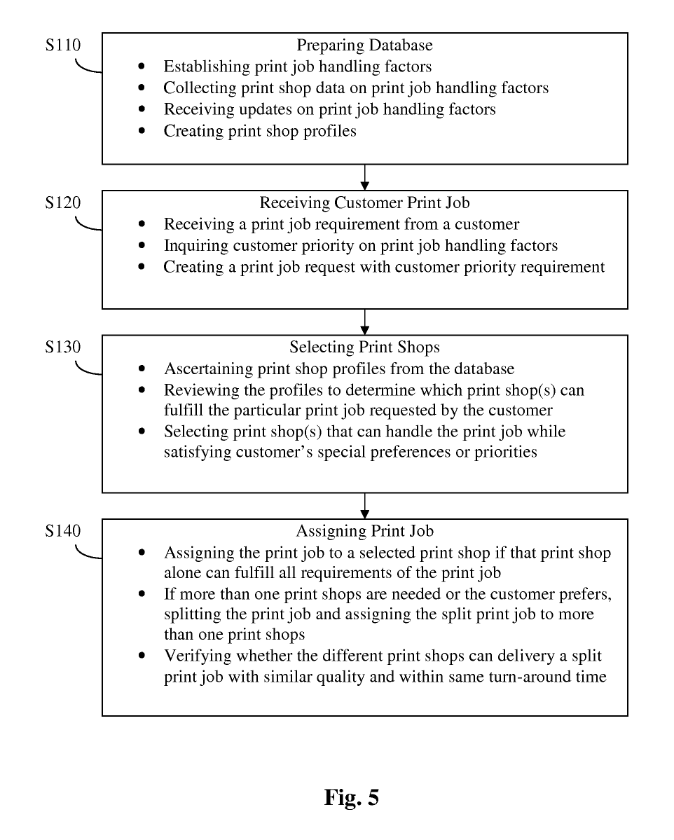

Referring to FIG. 5, there is illustrated an exemplary method and process of the present invention, which generally includes the basic steps of: a data preparation step during which available profiles of participating print shops including print job handling factors are gathered, sorted and stored in a database (Step S110), a customer requesting step during which a customer is specifying a print job's requirements (Step S120), a selection process during which print shop profiles are reviewed and which one or more print shops can fulfill the particular print job requested by the customer is determined (Step S130), a job assignment step during which a print job is assigned to a selected print shop if that print shop alone can fulfill all requirements of the print job or a print job is split and assigned to more than one print shops if it is necessary to do so in order to fulfill all requirements of the printer job (Step 140).

According to one embodiment of the present invention method and process, in the data preparation stage (Step S110), the platform service provider will first establish a set of print job handling factors for gathering data from participating print shops and establishing profiles for these print shops. Such factors may include the location of the print shop, the weather, road, power supply (and so on) conditions at the location of the print shop, the number, type and model of the printing systems (servers, printers, etc.) installed in the print shop, the type and version of the software programs installed on the print shop server or computers for handling print jobs, the network arrangement of the print shop, the number of employees or technicians that can operate the printing system, the type of paper, ink and other consumable materials used and stocked by the print shop, the finishing options available at the print shop, the pricing structure of the print shop, the capacity of the print shop, the turn-around time of the print shop, the delivery method and speed of the print shop, etc. All these factors are designed to measure or determine primarily the printing capacity of a print shop, and how fast and at what cost a print job can handle a print job, which are unique and crucial for the printing industry and for a customer to select a suitable print shop to handle a specific print job. Information and data related to these factors may be collected by the platform server 4 from the print shop servers 8 via the Internet 2, or alternatively be submitted to the platform server 4 via the Internet 2 from the print shop server 8 of participating print shops. The collected or submitted information and data are stored in the database as the profiles of the print shops. As a person who is skilled in the relevant art will appreciate, Step 110 does not need to be executed every time the exemplary method or process is executed. In other words, once the available profiles of the print shops have been gathered and the database is built up, the method or process may be initiated from Step 120 next time without first gathering or updating the data from participating print shops.

The database and profiles of the participating print shops may be updated periodically or as needed either by the online platform provider or the print shops, or automatically by software programs executed on the platform server 4 and/or the print shop servers 8. The print shops may also manually update their information by telephone or facsimile communication, upon which the personnel of the platform provider may input the updated information into the database on the platform server 4. It is preferable to have the print shops to constantly update their information, particularly the ones related to their capacity, such as machine down, current backlog, etc. This will ensure that the database always contain updated and current information of the print shops.

In the next step (Step S120), the online platform receives a print job from a customer. The customer may use a customer computer 6 to log-on to a website provided by the platform server 4 through the Internet 2. The platform server 4 will execute the exemplary software program of the present invention to allow the customer's input and submission of the print job. Alternatively the customer may execute a customer-end application module of the exemplary software program of the present invention on the customer's computer 6 to generate a print job submission and send it to the platform server 4 through the Internet 2. Alternatively a customer may submit a print job request by telephone or facsimile communication, upon which the personnel of the platform provider may input the customer's print job request on the platform server 4.

The initial print job request may include print job specifications such as the type of printing wanted (color, black and white, mixed, etc.), the finishing requirements (e.g., stapled, bounded, etc.), the quantity, the time the print job needs to be done (turn-around time or deadline), delivery location, etc. The software program may also provide further options to the customer about the customer's particular preferences, for example whether the customer wants to have the print job done at least cost (i.e., price priority), or is willing to pay more for better quality such as by using higher-grade paper or special ink (quality priority) or for quicker turn-around time or faster delivery (i.e., speed priority). Some times the customer may have other specific preferences. For example, a customer may really prefer to have the print job handled by a local but small print shop. The customer's priority and/or other preferences can be used to fine-tune the process of selecting the print shops and assigning the print job.

In the next step (Step S130), the exemplary software program of the present invention running on the platform server 14 will retrieve print shop profiles from the database to see what print shops are suitable for the customer's specific print job request, which may depend on a particular print shop's availability, pricing, capacity, delivery speed, etc. Many times there may be one print shop that can handle the print job while satisfying all specific preferences or needs of the customer. But at times more than one print shops may be needed to handle the print job. For example, a print job requires printing 1,000 copies of a brochure. Print shop A can print all 1,000 copies of the brochure for a total price of X, while print shop B can print 500 copies for a price of Y and print shop C can print the other 500 copies for a price of Z, but the total price of print shops B and C handle is cheaper than the price X of print shop A, i.e., Y+Z<X. In this case if the customer has a price priority or least-cost preference, then print shops B and C may be selected to handle the print job, if they can delivery similar quality jobs within the same turn-around time. Another example would be that the a customer prefers a local print shop to handle the print job but no such local print shop alone may be able to handle the print job due to the fact that they are too small to finish the print job by the deadline although they are qualified in terms of the other selection criteria or factors provided by the customer (e.g., have the right pricing or printer/paper/ink/finishing options). In such a case, it may be suitable to split a large print job into several smaller print jobs to assign them to local/smaller print shops to satisfy the customer's preference of using local (even smaller) print shops.

In the next step (Step S140), the platform service provider assigns the print job to a selected print shop if it is determined that the selected print shop alone can fulfill all requirements of the print job. However, if it is determined that more than one print shops are needed or the customer prefers to use more than one print shops for whatever reasons (such as for a lower price or faster delivery), the platform service provider can split the print job and assign the split print job to more than one print shops. When a print job is split and assigned to different print shops, the platform service provider may want to verify whether the different print shops can delivery the split print job with similar quality and within same turn-around time as the customer requested. For example, if a print job contains color printing and is split and assigned to two print shops, then it may be desirable to verify that the output from the two print shops are color matched. Such color match verification can be achieved by determining whether these print shops can exchange their color profiles of their printers each other or not. The print job assignment can be sent by the platform server 4 via the Internet 2 to the print shop server 8 of the selected print shop, so the print shop can go ahead and print the job. Alternatively, the platform server 4 may notify the customer which print shop is selected by sending a message via the Internet 2 to the customer's computer 6, so that the customer can send the print job directly from the customer computer 6 via the Internet 2 to the print shop server 8 of the selected print shop.

The above described exemplary system, method and process of the preferred embodiments of the present invention has many advantages. It provides best printing options to the customers, and also creates a marketplace for the print shops through which multiple print shops can market their services to the customers and the customers can select a best choice print shop or print shops to handle their print jobs. As different print shops may have different situation such as different printing capacity, pricing structure, delivery speed, e.g., each of them has its unique strengths and weaknesses. Through the present invention system and process, the customers can benefit from the strengths of the print shops best suited for their print jobs. So the present invention system and process create a computer implemented or computerized “clearing house” for the print shops that automates the “shopping around town” process for a customer to shop around town for the print shop to best handle the customer's print job. As many data that are unique and particularly important to the printing industry (such as printing capacity of a print shop) are collected from and constantly updated by the print shops and stored in the database profiles of the print shops, the customers are benefited from the information contained in these data profiles which help the process to select one or more print shops that are best suited for a customer's particular print job requirements or specifications. With the ability to take into consideration in the selection process of the customers' specific priority and preferences (e.g., quality priority, price priority, delivery time priority), and the flexibility in clustering the print jobs at the multiple-shop level, the customer's need is best service either by one best suitable print shop, or more than one suitable print shops that when working in a partnership manner provide the best result to fit the customer's specific preference or priority. The automated process provides the customers an experience similar to “online shopping” while the print jobs are handled in a “real time manufacturing” manner, and can be easily adapted and applicable to “manufacturing on demand” industries. The platform service provider may be self-sustained by generating a revenue from the process by, for example, charging the participating print shops on a commission basis, or a fixed fee per print job assigned, or a membership due, etc., as it provides an effective way to promote and reward print shops that can best fulfill customers' print job needs, while operating and organizing the participating print shops as a universal partnership in which incoming print jobs are assigned to appropriate print shops to provide better printing services to the customers as a whole, because the system and process aim to try to find a best solution to satisfy the customer's requests in all situations, including the situations where no one print shop can handle a specific print job alone, by finding multiple suitable print shops to handle the print job and splitting the print job to multiple print shops. To the customer, the print job process seems identical to a job sent to a single printer since all requirements of the customer's print job are satisfied similarly with matched quality, unified pricing and the same turn-around time.

It will be apparent to those skilled in the art that various modification and variations can be made to the methods of the present invention without departing from the spirit or scope of the invention. Thus, it is intended that the present invention cover modifications and variations that come within the scope of the appended claims and their equivalents.

What is claimed is:

1. A method for fulfilling a customer's print job needs, comprising the steps of:
a. receiving the print job with particular requirements from the customer;
b. retrieving from a database profiles of a multiplicity of participating print shops to determine which print shop or print shops are suitable to handle the print job by matching all of the particular requirements; and
c. if it is determined that the print job is capable of being handled by a cooperation of multiple print shops, then split the print job and assign the split print job to a plurality of suitable print shops that together can best match all of the particular requirements of the print job.

2. The method according to claim 1, further comprising a step of collecting information and data from the participating print shops to prepare their profiles and storing the profiles in the database.

3. The method according to claim 2, further comprising a step of updating the information and data and the profiles of the participating print shops.

4. The method according to claim 1, wherein the print job requirements include at least one customer's priority preference.

5. The method according to claim 1, further comprising the step of inquiring the customer about the customer's priority preference.

6. The method according to claim 4 or 5, wherein the customer's priority preference is one of a group of priorities including a price priority, a quality priority and a delivery time priority.

7. The method according to claim 1, further comprising a step of establishing a set of print job handling factors for determining whether a print shop is suitable for a print job.

8. The method according to claim 7, wherein the set of print job handling factors includes print shop printing capacity.

9. The method according to claim 1, further comprising a step of verifying whether the plurality of suitable print shops can delivery the split print job with matching printing quality.

10. The method according to claim 1, further comprising a step of providing an online platform to carry out one or more of the steps.

11. A system for fulfilling a customer's print job needs comprising at least one data processing apparatus having a non-transitory memory storing a computer software program and a processor executing the computer software program, wherein the computer software program includes program code configured to cause the at least one data processing apparatus to execute a process which comprises the steps of:
a. receiving the print job with particular requirements from the customer;
b. retrieving from a database profiles of a multiplicity of participating print shops to determine which print shop or print shops are suitable to handle the print job by matching all of the particular requirements; and
c. if it is determined that the print job is capable of being handled by a cooperation of multiple print shops, then split the print job and assign the split print job to a plurality of suitable print shops that together can best match all of the particular requirements of the print job.

12. The system according to claim 11, wherein the process further comprises a step of collecting information and data from the participating print shops to prepare their profiles and storing the profiles in the database.

13. The system according to claim 12, wherein the process further comprises a step of updating the information and data and the profiles of the participating print shops.

14. The system according to claim 11, wherein the print job requirements include at least one customer's priority preference.

15. The system according to claim 11, wherein the process further comprises the step of inquiring the customer about the customer's priority preference.

16. The system according to claim 14 or 15, wherein the customer's priority preference is one of a group of priorities including a price priority, a quality priority and a delivery time priority.

17. The system according to claim 11, wherein the process further comprises a step of establishing a set of print job handling factors for determining whether a print shop is suitable for a print job.

18. The system according to claim 17, wherein the set of print job handling factors includes print shop printing capacity.

19. The system according to claim 11, wherein the process further comprises a step of verifying whether the plurality of suitable print shops can delivery the split print job with matching printing quality.

20. The system according to claim 11, further comprising an online platform to carry out one or more of the steps of the process.

21. A computer software program product having a computer readable program code embedded in a computer usable non-transitory storage medium for controlling at least one data processing apparatus, the computer readable program code configured to cause the at least one data processing apparatus to execute a process which comprises the steps of:
a. receiving the print job with particular requirements from the customer;
b. retrieving from a database profiles of a multiplicity of participating print shops to determine which print shop or print shops are suitable to handle the print job by matching all of the particular requirements; and
c. if it is determined that the print job is capable of being handled by a cooperation of multiple print shops, then split the print job and assign the split print job to a plurality of suitable print shops that together can best match all of the particular requirements of the print job.

22. The computer software program product according to claim 21, wherein the process further comprises a step of collecting information and data from the participating print shops to prepare their profiles and storing the profiles in the database.

23. The computer software program product according to claim 22, wherein the process further comprises a step of updating the information and data and the profiles of the participating print shops.

24. The computer software program product according to claim 21, wherein the print job requirements include at least one customer's priority preference.

25. The computer software program product according to claim 21, wherein the process further comprises the step of inquiring the customer about the customer's priority preference.

26. The computer software program product according to claim 24 or 25, wherein the customer's priority preference is one of a group of priorities including a price priority, a quality priority and a delivery time priority.

27. The computer software program product according to claim 21, wherein the process further comprises a step of establishing a set of print job handling factors for determining whether a print shop is suitable for a print job.

28. The computer software program product according to claim 27, wherein the set of print job handling factors includes print shop printing capacity.

29. The computer software program product according to claim 21, wherein the process further comprises a step of verifying whether the plurality of suitable print shops can delivery the split print job with matching printing quality.

30. The computer software program product according to claim 21, further comprising an online platform to carry out one or more of the steps of the process.
